(19) United States
(12) Patent Application Publication
(10) Pub. No.: US 2025/0007447 A1
(43) Pub. Date: Jan. 2, 2025

(54) MAXIMIZING OUTPUT OF A SOLAR ENERGY SYSTEM UNDER REDUCED IRRADIANCE CONDITIONS

(71) Applicant: SOLARGIK LTD, JERUSALEM (IL)

(72) Inventors: Gil Kroyzer, Jerusalem (IL); Israel Kroizer, Jerusalem (IL); Noam Noy, Netanya (IL); Matanya Wiener, Jerusalem (IL); Morag Am Shallem, Jerusalem (IL)

(21) Appl. No.: 18/214,953

(22) Filed: Jun. 27, 2023

(51) Int. Cl. H02S 20/32; H02J 3/38

(52) U.S. Cl. CPC H02S 20/32; H02J 3/38

(57) ABSTRACT

A method of operating a solar energy system comprises: periodically reorienting the plurality of PV modules to maximize an instantaneous electrical output from during a first period of time characterized by a predominance of a direct solar component, and reorienting the plurality of PV modules to a plurality of orientations so as to maximize cumulative electrical output over the duration of a second period of time characterized at least at a beginning thereof by a predominance of a diffuse solar component and further characterized at least at an end thereof by a predominance of the direct solar component. At least a first reorienting during the second period of time is effective to pivot the plurality of PV modules away from an on-sun orientation.

### FIELD OF THE INVENTION

The present invention relates to solar energy systems and in particular to devices and methods for maximizing the electrical output of photovoltaic (PV) assemblies using tracking systems configured to pivot the PV assemblies away from direct on-sun orientations.

### BACKGROUND

Achieving a diversified low-carbon emissions energy economy has been limited by economic and technological limitations. Solar energy systems comprising photovoltaic (PV) modules are commonly deployed to capture energy from both direct and diffuse (including reflected) solar irradiance. Tracking PV systems are deployed in which PV modules are pivoted to reduce optical losses from the direct irradiance component, including the so-called cosine loses wherein the energy absorbed is a function of the cosine of the angle between the incidence vector and a normal vector of the PV module.

PV modules serve to generate electricity when solar illumination is incident upon the panels. Generated electricity is typically fed into an electrical grid of the city/locality.

A substantial majority of the solar energy converted to electricity is from the direct component of the general irradiance, while only a minority comes from the diffuse component. When the direct component is not predominant, for example when the sun is obscured by clouds or by ground-based objects such as trees or buildings, the tracking PV modules commonly in use today continue to track the position of the sun using sun-tracking algorithms. This is in order to capture the direct component immediately upon its becoming once again predominant, e.g., when the cloud cover moves on and the sun is revealed. However, this mode of operation often does not maximize the amount of solar energy converted by the tracking PV modules.

### SUMMARY

According to embodiments of the present invention, a method is disclosed for operating a solar energy system. The solar energy system comprises a plurality of photovoltaic (PV) modules and one or more drive systems configured to pivot the plurality of PV modules through respective ranges of orientations. The method comprises: (a) during a first period of time characterized by a predominance of a direct component in real-time solar irradiance incident on the plurality of PV modules, periodically reorienting the plurality of PV modules to maximize an instantaneous electrical output from photovoltaic conversion of the incident solar irradiance; and (b) during a second period of time characterized at least at a beginning thereof by a predominance of a diffuse component of the real-time solar irradiance incident on the plurality of PV modules and further characterized at least at an end thereof by a predominance of the direct component, reorienting the plurality of PV modules to a plurality of orientations so as to maximize a cumulative electrical output from photovoltaic conversion of the incident solar irradiance over the duration of the second period of time, wherein at least a first reorienting during the second period of time is effective to pivot the plurality of PV modules away from an on-sun orientation.

In some embodiments, the at least a first reorienting can be towards an orientation having a measured or calculated diffuse irradiance component greater than at the on-sun orientation. In some embodiments, it can be that the orientation having a measured or calculated diffuse irradiance component greater than at the on-sun orientation is determined using an image from a sky-facing optical camera. In some embodiments, it can be that the measured or calculated diffuse irradiance component greater than at the on-sun orientation is a maximum diffuse irradiance component at or proximate to a time of the at least a first reorienting during the second period of time.

In some embodiments, the at least a first reorienting during the second period of time can be towards an orientation having a measured or calculated total irradiance greater than at the on-sun orientation. In some embodiments, it can be that the orientation having a measured or calculated total irradiance greater than at the on-sun orientation is determined using an image from a sky-facing optical camera. In some embodiments, it can be that the measured or calculated total irradiance greater than at the on-sun orientation is a maximum total irradiance at or proximate to a time of the at least a first reorienting during the second period of time.

In some embodiments, the orientation having a measured or calculated diffuse irradiance component greater than at the on-sun orientation can be determined using an irradiance scanner having a maximum angular speed at least 5 times faster than a maximum angular speed of the PV modules when the PV modules are pivoted by the one or more drive systems.

In some embodiments, the orientation having a measured or calculated total irradiance greater than at the on-sun orientation can be determined using an irradiance scanner having a maximum angular speed at least 5 times faster than a maximum angular speed of the PV modules when the PV modules are pivoted by the one or more drive systems.

In some embodiments, it can be that at least one reorienting during the second period of time—i.e., at least one reorienting that is not the first reorientation—is towards an on-sun orientation, and is carried out in response to a predicted increase in the direct component. In some embodiments, the predicted increase in the direct component can be based on an image from a sky-facing optical camera.

In some of the embodiments in which an irradiance scanner is utilized, it can be that the one or more drive systems are configured to pivot the plurality of PV modules about respective single longitudinal axes, the respective single longitudinal axes of the plurality of PV modules are not all parallel to each other, the irradiance scanner comprises at least two irradiance sensors oriented in different directions.

In some of the embodiments in which an irradiance scanner is utilized, it can be that the one or more drive systems are configured to pivot the plurality of PV modules through at least respective hemispheres of orientations, and the irradiance scanner comprises at least two irradiance sensors oriented in different directions.

In some embodiments, a controller can be configured to carry out the method according to any of embodiments disclosed hereinabove, combining any or all of the features disclosed.

According to embodiments of the present invention, a solar energy system comprises: (a) a plurality of photovoltaic (PV) modules; (b) one or more drive systems; and (c) a control system configured to control the one or more drive systems to pivot the plurality of PV modules through respective ranges of orientations, wherein: (i) during a first period of time characterized by a predominance of a direct component in real-time solar irradiance incident on the plurality of PV modules, the pivoting includes periodically reorienting the plurality of PV modules to maximize an instantaneous electrical output from photovoltaic conversion of the incident solar irradiance; and (ii) during a second period of time characterized at least at a beginning thereof by a predominance of a diffuse component of the real-time solar irradiance incident on the plurality of PV modules and further characterized at least at an end thereof by a predominance of the direct normal component, the pivoting includes reorienting the plurality of PV modules to a plurality of orientations so as to maximize a cumulative electrical output from photovoltaic conversion of the incident solar irradiance over the duration of the second period of time, wherein at least a first reorienting during the second period of time is effective to pivot the plurality of PV modules away from an on-sun orientation.

In some embodiments, the solar energy system can additionally comprise a sky-facing optical camera, and the controller can be configured to receive an image therefrom and determine, based on the image, an orientation having a measured or calculated diffuse irradiance component greater than at the on-sun orientation. In some embodiments, the at least a first reorienting can be towards the determined orientation.

In some embodiments, the solar energy system can additionally comprise an irradiance scanner having a maximum angular speed as least 5 times faster than a maximum angular speed of the PV modules when the PV modules are pivoted by the one or more drive systems, and the controller can be configured to determine, using the irradiance scanner, an orientation having a measured or calculated diffuse irradiance component greater than at the on-sun orientation. In some embodiments, the at least a first reorienting can be towards the determined orientation.

According to embodiments of the present invention, a method is disclosed for operating a solar energy system. The solar energy system comprises a plurality of photovoltaic (PV) modules and one or more drive systems configured to pivot the plurality of PV modules through respective ranges of orientations. The method comprises: (a) periodically reorienting the plurality of PV modules to minimize an angular-dependent loss in power output for respective successive sun angles; (b) detecting an obscuration of the sun; (c) in response to the detection, reorienting the plurality of PV modules away from an on-sun orientation; (d) predicting an interval until a cessation of the obscuration based on an image received from a sky-facing camera; and (e) reorienting the plurality of PV modules back towards an on-sun orientation based on the prediction of the interval.

In some embodiments, reorienting the plurality of PV modules away from the on-sun orientation can be towards an orientation having a measured or calculated diffuse irradiance component greater than at the on-sun orientation. In some embodiments, it can be that reorienting the plurality of PV modules away from the on-sun orientation is towards an orientation having a measured or calculated total irradiance greater than at the on-sun orientation. In some embodiments, it can be that reorienting the plurality of PV modules away from the on-sun orientation and reorienting the plurality of PV modules back toward the on-sun orientation are effective to maximize a cumulative electrical output from photovoltaic conversion of incident solar irradiance over a duration comprising at least the interval.

In some embodiments, wherein the predicting can be carried out before reorienting the plurality of PV modules away from the on-sun orientation.

In some embodiments, a controller can be configured to carry out the method according to any of embodiments disclosed hereinabove, combining any or all of the features disclosed.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 shows a block diagram of a solar energy system, according to embodiments of the present invention.

FIG. 2 shows a schematic layout of selected components of a solar energy system according to embodiments of the present invention.

FIG. 3 shows a block diagram of a control system for a solar energy system, according to embodiments of the present invention.

FIG. 4 shows a block diagram relating to a forecasting process, according to embodiments of the present invention.

FIG. 5 is a schematic illustration of a PV module exposed to different components of solar irradiance, according to embodiments of the present invention.

FIG. 6 shows a flowchart of a method for operating a solar energy system, according to embodiments of the present invention.

FIG. 6 shows a timeline of respective time periods during which steps of a method are carried out, according to embodiments of the present invention.

FIGS. 8A and 8B are schematic illustrations of a PV module pivoted to different orientations, according to embodiments of the present invention.

FIG. 9 is a schematic illustration of a PV module, a sky-facing optical sensor and an irradiance scanner, according to embodiments of the present invention.

FIGS. 10 and 11 are schematic illustrations of PV modules and irradiance scanners comprising multiple irradiance sensors, according to embodiments of the present invention.

FIG. 12 FIG. 6 shows a flowchart of a method for operating a solar energy system, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Embodiments disclosed herein relate to re-orienting modules of photovoltaic (PV) modules of a solar energy system when the direct component of the solar irradiances ceases to become predominant. This can result from full or partial occultation of the sun by clouds or by ground based objects such as, for example, buildings or neighboring PV modules. In current solar energy systems, the PV modules continue to track the sun position using a sun-tracking algorithm, so that the PV modules will be facing in the sun direction when the sun reappears. In some cases, it is possible to re-orient the modules away from the ‘on-sun’ position to achieve a higher instantaneous energy output. For example, a portion of the sky that is angularly displaced from the cloud-obscured sun may provide a higher amount of diffuse solar radiation. However, re-orienting the PV modules to face the higher-diffuse irradiance can come with a price. The PV modules may risk being ‘caught’ being away from the on-sun position when clouds move on or dissipate and the sun reappears, leading to the loss of valuable energy from the moment when the direct component returns to predominance until the moment when the slowly pivoting PV modules eventually catch up. According to the instant disclosure, it is possible to predict when the sun will reappear, and start moving the modules back from the high-diffuse irradiance orientation so as to reach the on-sun position before the sun reappears, at least a majority of the time. The prediction can be done by a local forecasting system that is part of, or associated with the controller of the PV module, using inputs from local sensors such as sky-facing cameras and/or irradiance scanners.

A ‘solar energy system’ as used herein means a system for generating electricity using an array of PV modules. The system can include an inverter for converting the direct-current (DC) electricity generated by the PV modules to alternating current (AC) electricity, e.g., for delivery to an electricity grid.

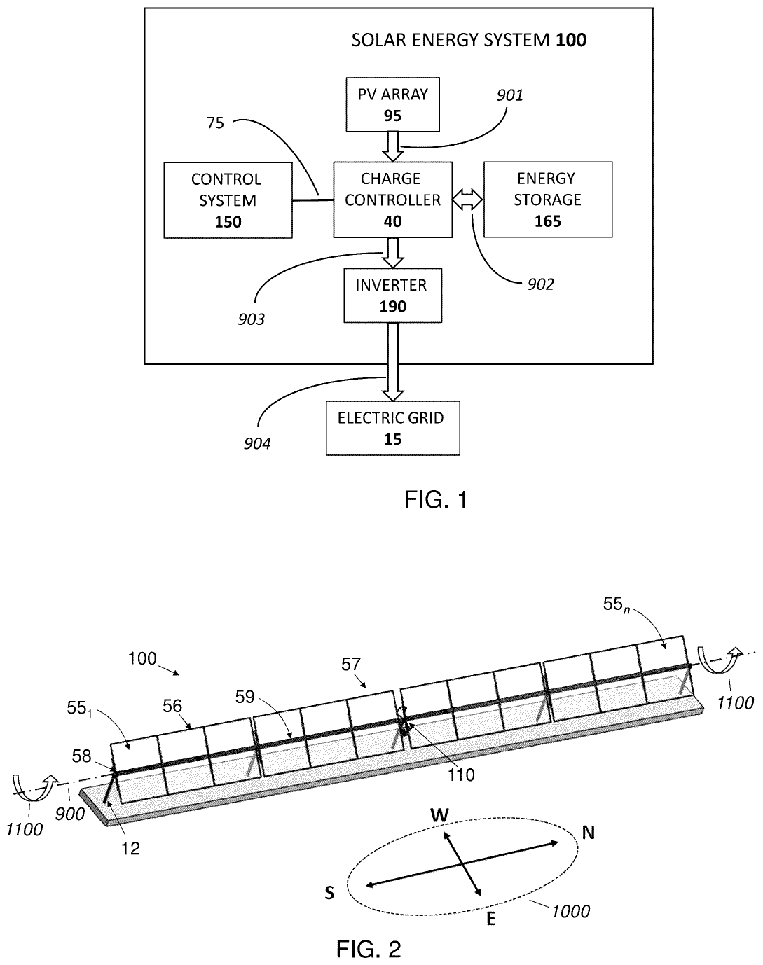

Referring now to the figures, and in particular to FIG. 1, a solar energy system 100 according to embodiments includes a PV array 95 comprising a plurality of PV modules 57 (shown in FIG. 2). In embodiments, the modules 57 of the PV array 95 includes a tracking component, i.e., a solar tracker, for increasing cumulative electricity generated over the course of a period of time.

A solar tracker, or simply ‘tracker’, is an arrangement that changes the orientation of the PV panels in response to commands from a controller. Whenever direct solar irradiance is available, the tracker is oriented and incrementally pivoted so as to capture, i.e., convert, the highest possible proportion of the direct irradiance falling on the panels over the course of nearly any given period of time. In some instances, the tracker is oriented to capture and convert energy up to a given maximum or setpoint. Capture and conversion of the diffuse radiation component of the incident solar irradiance is considerably smaller than that of the direct component, and therefore the tracking is largely unaffected by distribution of diffuse radiation. In most cases, variation in the distribution of diffuse radiation becomes important only when the direct component is eliminated or reduced so as to no longer be the predominant component of the incident solar irradiance.

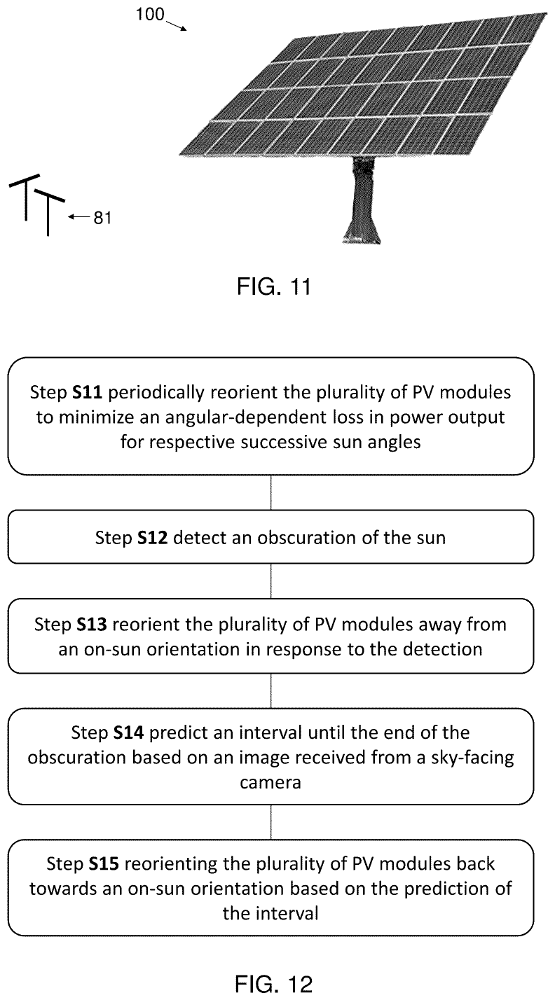

A single-axis tracker is one that rotates PV panels around a single axis, usually rotating from facing east to facing west over the course of a day around a north-south axis. A double-axis, or two-axis, tracker is one that is designed to generally have the PV panels ‘face’ the sun directly at all times so as to capture and convert as much energy as possible from available direct irradiance by reducing the angle between a normal vector of the PV panels and incident direct irradiance to zero, or substantially zero, in not just one plane but all planes. Some double-axis trackers operate using Euler angles and do not, strictly speaking, rotate the PV panels about two Cartesian axes, but the results are substantially the same. The embodiments disclosed herein, other than the discussion of FIG. 11, are described in terms of single-axis tracking, but their application, mutatis mutandis, to double-axis tracking, is within the scope of the present invention.

The solar system 100 of FIG. 1 additionally includes an inverter 190 for conversion of DC electricity to AC. An inverter can include electronic circuitry, for example for synchronizing the phase, and for matching the voltage and frequency of the power output to those of the grid.

FIG. 1 further illustrates a non-limiting example of a power flow scheme for a solar energy system 100: power generated by the PV array 95 flows to a charge controller 40 as indicated by arrow 901. Two-way power flow takes place between the charge controller 40 and an energy storage device 165, as indicated by two-way arrow 902. Power from the PV array 95 and the energy storage device 165 flows through the charge controller 40 to the inverter 190, as indicated by arrow 903. The inverter 190 can deliver energy to the electric grid 15, as indicated by arrow 904.

Referring now to FIG. 2, a solar energy system 100 according to embodiments, employing single-axis tracking, includes one or more PV modules 57. The PV module 57 includes n PV panels 55₁ through 55ₙ, joined to a support subassembly 58. The support subassembly 58 includes frames 56 for mounting the PV panels 55, and a central elongated member 59 to which the frames 56 are joined. The central elongated member 59 serves to transfer a torque to rotate the frames 56 as a unit together with the central elongated member 59 and the PV panels 55. The PV module 57 is rotated about a central longitudinal axis indicated in FIG. 2 by dashed line 900, and the rotation is schematically represented by arrows 1100. The central elongated member 59 is pivotably supported by ground supports 12. As shown by axes 1000, the panels are facing generally east, indicating that FIG. 2 shows a morning orientation. The tracking of the PV module 57 is shown as being east-west tracking as is the case in the vast majority of current installations of PV modules, but the principles disclosed here are equally applicable to north-south tracking systems, mutatis mutandis. A drive system 110 according to embodiments includes a motor assembly and a pivot wheel, and is also supported by a ground support 12. The drive system 110, as shown in FIG. 2, can be located in the center of the PV assembly 57. In other examples, a drive system 110 can be located elsewhere and/or configured differently than the example illustrated. In embodiments, the drive system 110 is operable to rotate a pivot wheel positioned to rotate the central elongated member 59 and, with it, the PV module 57.

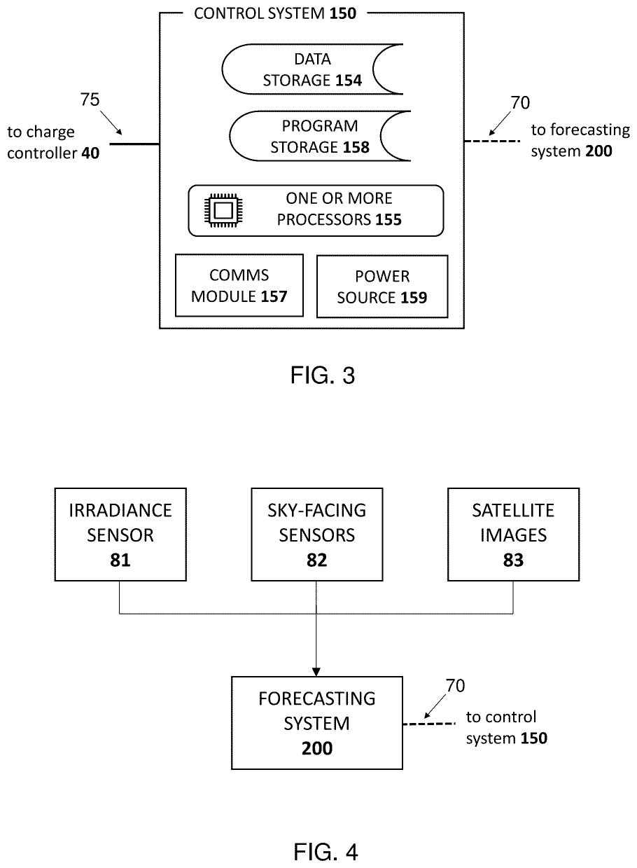

A control system 150, (also called a ‘controller’) for a solar energy system 100, according to embodiments, is illustrated schematically in FIG. 3 to show selected components. The exemplary control system 150 of FIG. 2 includes one or more computer processors 155, a computer-readable storage medium 158, a communications module 157, and a power source 159. The computer-readable storage medium 158 can include transient and/or transient storage, and can include one or more storage units, all in accordance with desired functionality and design choices. The storage 158 can be used for any one or more of: storing program instructions, in firmware and/or software, for execution by the one or more processors 155 of the control system 150. In embodiments, the stored program instructions include program instructions for operating a solar energy system 100 in accordance with any of the embodiments disclosed herein. Data storage 154, if separate from storage 158, can be provided for historical data, e.g., actual irradiance and/or forecast values, e.g., forecasted irradiance values, and other data related to the operation of the solar energy system 100. In some embodiments, the two storage modules 154, 158 form a single module. The communications module 159 is configured to establish communications links, e.g., via communication arrangements 70 with a forecasting module or system 200 (described below and illustrated schematically in FIG. 3), and with the charge controller 40 via communications arrangements 75. In some embodiments, a control system 150 does not necessarily include all of the components shown in FIG. 2. The terms “communications arrangements” or similar terms such as “communications links” as used herein mean any wired connection or wireless connection via which data communications can take place. Non-limiting and non-exhaustive examples of suitable technologies for providing communications arrangements include any short-range point-to-point communication system such as IrDA, RFID (Radio Frequency Identification), TransferJet, Wireless USB, DSRC (Dedicated Short Range Communications), or Near Field Communication; wireless networks (including sensor networks) such as: ZigBee, EnOcean; Wi-fi, Bluetooth, TransferJet, or Ultra-wideband; and wired communications bus technologies such as .CAN bus (Controller Area Network, Fieldbus, FireWire, HyperTransport and InfiniBand.

In embodiments, it can be desirable to access forecasted meteorological data and other sensor data, e.g., for predicting the intensity of the various components of solar radiance and calculating therefrom electrical output of a PV array for an imminent future time period, e.g., a future time period beginning immediately following the time of the forecasting. In an example, the forecasting and predicting can be calculated using and/or on the basis of images captured by a sky-facing optical sensor, e.g., a sky-facing camera. A sky-facing camera can capture images of the sky over the solar energy system, including multiple successive images that can be used, e.g., to interpret movements of clouds. FIG. 4 shows examples of components, according to embodiments, provided for working with a short-term forecasting module or system 200. The non-exhaustive list of components includes one or more irradiance sensors 81, sky-facing optical sensors 82, and a source of satellite imagery 83.

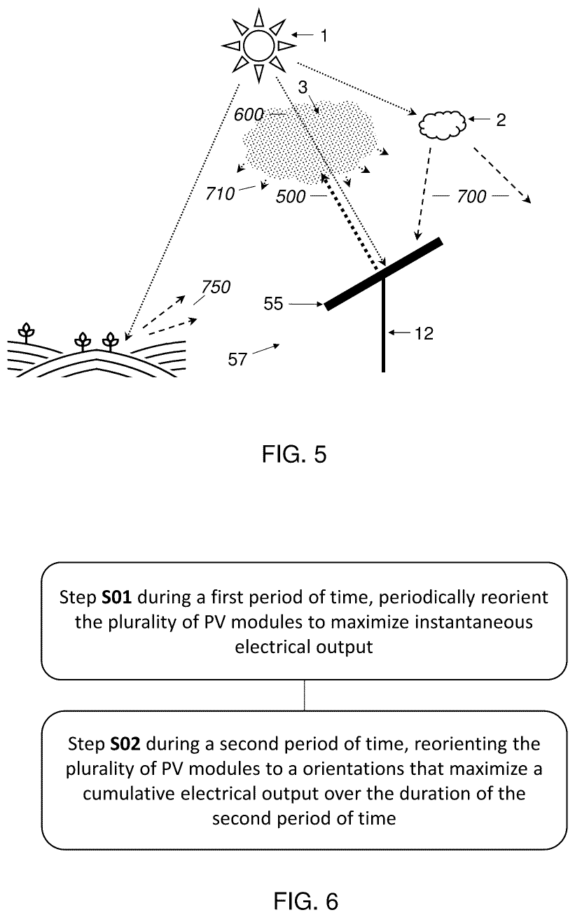

FIG. 5 illustrates the various components of solar irradiance with reference to a PV array. The module 57 is drawn schematically as an end view showing the ground support 12 and the PV panels 55. In the illustration of FIG. 5, the PV module 57 is oriented on-sun, i.e., faces the sun 1 directly on at least one axis, and thus the direct component 600 impinges upon the surface of the panels 55 at a right angle to the panels 55, i.e., the angle between the direct component 600 and a normal vector 500 of the panels 55 is zero, or substantially zero, or substantially zero in at least one plane. In a plane orthogonal to the illustrated plane of the figure, the vector 500 may or may not be parallel to the vector of the direct component 600 in a single-axis tracking system. Some of the direct radiation 600 of FIG. 5 reaches clouds 2 and the fraction that is not absorbed is scattered and further propagated as diffuse radiation 700. The direct irradiance 600, even in the absence of clouds, passes through particulate matter 3 in the atmosphere including, e.g., dust, water vapor, organic matter, etc., and a portion of the irradiation, e.g., 1-15%, or 5-10%, is scattered as diffuse radiation 710. Yet another type, or component, of diffuse radiation is reflected solar energy (albedo), shown in FIG. 5 as reflected off the surrounding landscape by diffuse radiation 750. Some PV modules have panel panels on the ‘back side’ as well in order to convert additional solar radiation to electricity, e.g., reflected and diffused radiation 750. Thus, the diffuse component of solar irradiance as discussed hereinbelow can include any combination of cloud-diffused radiation 700, particulate-diffused radiation 710, and reflected radiation 750.

Referring now to FIG. 6, a method is disclosed for operating a solar energy system 100, e.g., the solar energy system 100 of FIG. 1. According to the method, the solar energy system 100 comprises a plurality of PV modules 57 and one or more drive systems 110 configured to pivot the plurality of PV modules through respective ranges of orientations. As illustrated by the flow chart in FIG. 6, the method comprises at least the two method steps S01 and S02.

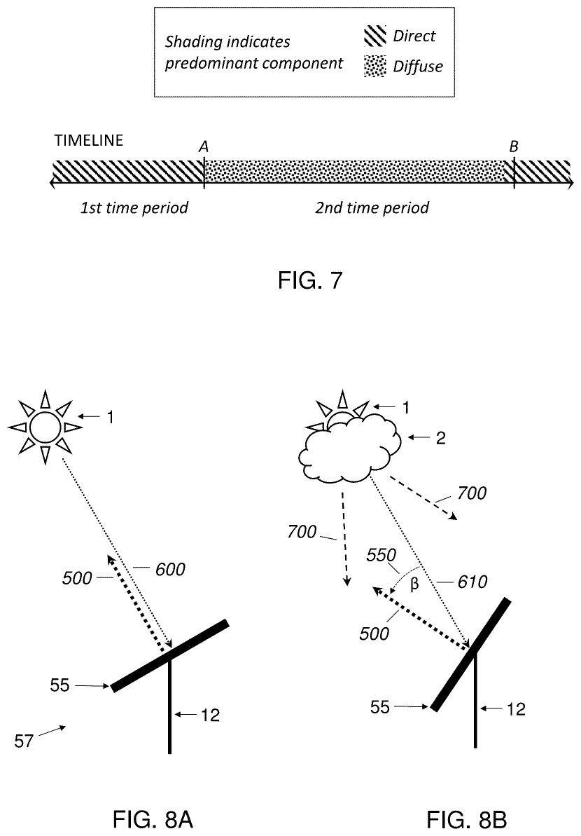

Step S01 includes periodically reorienting, i.e., pivoting, the plurality of PV modules 57 to maximize an instantaneous electrical output from photovoltaic conversion of the incident solar irradiance. Step S01 is carried out during a first period of time characterized by a predominance of the direct component 600 in the real-time solar irradiance incident on the plurality of PV modules 57. An example of a period of time characterized by predominance of the direct component 600 is when the sun is unobscured, or at most partly obscured but only to an extent that the direct component 600 of the irradiance is less than the diffuse component. During that time, according to the method step S01, the PV modules remain in an ‘on-sun’ orientation in order to maximize instantaneous electricity production. An example of a PV module 57 in an on-sun orientation during the first time period according to Step S01 is illustrated schematically in FIG. 8A. As shown in FIG. 8A, the normal vector 500 of the PV panels 55 is parallel to the direct irradiance vector 600, so as to minimize angle-dependent optical losses in electricity production. As is known in the art, the on-sun orientation is maintained over time by incrementally pivoting the PV panels 55—either continuously or in discrete steps—to track the apparent position of the sun 1.

Step S02 includes reorienting the plurality of PV modules 57 to a plurality of orientations so as to maximize a cumulative electrical output from photovoltaic conversion of the incident solar irradiance over the duration of a second period of time, e.g., a second period of time that immediately follows the first period of time of Step S01. The second period of time is characterized at least at a beginning thereof by a predominance of a diffuse component (700, 710 and/or 750) of the real-time solar irradiance incident on the plurality of PV modules 57, e.g., after the obscuration of the sun, and further characterized, at least at the end of the second period of time, by a predominance of the direct component 600.

During the second period of time, the PV modules 57 are pivoted, at least with a first re-orientation of the time period, away from the on-sun orientation toward an orientation exhibiting a greater intensity of the diffuse component(s) 700, 710, 750, and/or of total irradiance. An illustrative and non-limiting example of carrying out Step S02 is shown in FIG. 8B, where the PV panels 55 are reoriented, as indicated by arrow 550 showing the pivoting of the normal vector 500 of the panels; the pivoting is to an orientation angularly displaced separated from the on-sun position 610 by an angle β. The on-sun position 610 in FIG. 8A is equivalent to the vector 600 of where the direct irradiance would be if the sun were not obscured.

In some embodiments, the first re-orienting (and not necessarily only the first re-orienting) is towards an orientation having a measured or calculated diffuse irradiance component greater than at the on-sun orientation. In some embodiments the first re-orienting is to a current maximum diffuse and/or total irradiance component, i.e., the measured or calculated diffuse (and/or total) irradiance component greater than at the on-sun orientation is a maximum diffuse (and/or total, respectively) irradiance component at or proximate to the time of the first reorienting during the second period of time. In some embodiments, the PV modules are re-oriented more than once to face different area of the sky as such higher-irradiance areas are identified by measurement or calculated.

In embodiments, an orientation having a measured or calculated diffuse irradiance component greater than at the on-sun orientation can be at least 10° away from the on-sun position, or at least 20° away, or at least 30° away, or at least 40° away, or at least 50° away, or at least 60° away, or at least 70° away, or at least 80° away, or at least 90° away, or even further away. In embodiments, the PV panels 55 can receive at least 10 W/m² more diffuse irradiation at such an orientation, in comparison to the on-sun orientation, or at least 20 W/m², or at least 30 W/m², or at least 40 W/m², or at least 50 W/m², or at least 60 W/m², or at least 70 W/m², or at least 80 W/m², or at least 90 W/m², or at least 100 W/m². In some embodiments, pivoting the PV modules 57 to different orientations during the second period of time are effective to maximize the total electricity produced over the course of the second period of time, i.e., not necessarily instantaneous electricity produced at any given moment. In some embodiments, the pivoting to different orientation(s) is effective to at least exceed the electricity that would be produced if the PV modules 57 remained in the on-sun orientation.

FIG. 7 shows a timeline that schematically illustrates certain characteristics of the first and second periods of time. During the first period of time, maximization of instantaneous electricity production is achieved by pivoting the PV modules 57 to maintain an on-sun orientation. As seen in FIG. 7, the first period of time is characterized by the direct component 600 being the predominant component of solar irradiance, and the first period of time ends with a change in this predominance, e.g., with the obscuration of the sun by clouds. In some embodiments, it is the identification of such an obscuration that triggers the first re-orientation. In some embodiments, it can be desirable to avoid maximizing instantaneous electricity production for some period of time, e.g., to avoid producing electricity that exceeds a limit such as a commercial limit or a technical limit of, e.g., an inverter or transmission facility. In such embodiments, it can be desirable to orient the PV modules at a set angle away from the on-sun normal orientation, so as to maintain the desired level of electricity production that is less than the theoretical maximum. In such embodiments, the expression ‘maximize instantaneous electricity production’ can be interpreted as ‘maintain instantaneous electricity production according to a desired limit’ during the first period of time.

As can be seen in FIG. 7, the direct component 600 returns to be the predominant component of the incident solar irradiance, at or before the end of the second period of time. In embodiments, the second period of time is brought to a close based on a prediction of the return of the direct component to be predominant at a predicted time. In such embodiments, the PV modules 57 are pivoted ‘back’ to the on-sun orientation, with the goal of ‘arriving’ at the on-sun orientation in time for the predicted return of the predominance of the direct component. In practice, returning to the on-sun orientation before the end of the second period of time means that at least one re-orientation during the second time period is away from the on-sun position, e.g., towards an orientation with a higher current diffuse or total irradiance, and at least one re-orientation during the second time period is towards the on-sun position. Returning to the on-sun orientation can involve returning to the on-sun orientation before the actual return of the direct-component predominance, i.e., the cessation of the obscuration of the sun by clouds. In some embodiments, the controller system 150 is programmed to have the PV modules 57 arrive back at the on-sun orientation before the cessation of the sub-obscuration all of the time or most of the time. In some embodiments, the controller system 150 is programmed to have the PV modules 57 arrive back at the on-sun orientation before the cessation of the sub-obscuration more often than arriving after the cessation of the sub-obscuration.

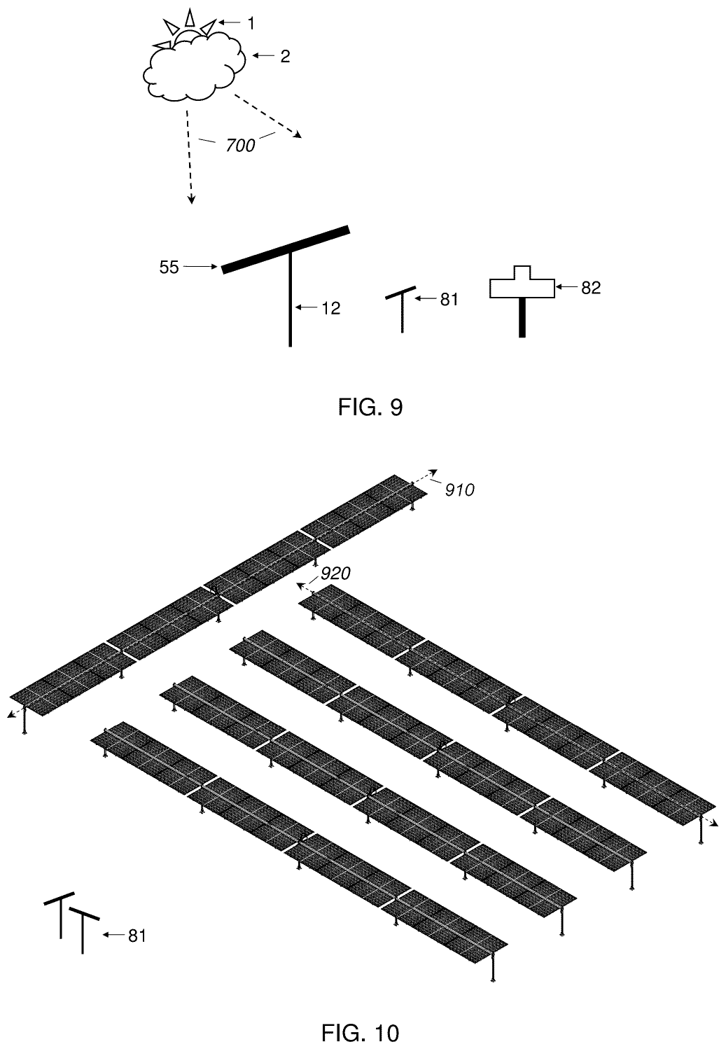

In embodiments, the prediction of the return of the direct-component predominance can be made using a sun-facing sensor 82 such as a sun-facing camera. Images obtained from such a camera are processed and analyzed using data-analysis techniques as are known in the art, such as (and not exhaustively) machine learning techniques. The sun-facing camera can provide single images or continuous streams of images, and the images can show the entire hemisphere of the sky or any portion thereof. An example of a sky-facing camera 82 in proximity to a PV module 57 is shown in FIG. 9.

In some embodiments, an orientation offering measured or calculated diffuse (and/or total) irradiance greater than at the on-sun orientation is determined by using an irradiance scanner 81 having a maximum angular speed faster than that of the PV modules. The drive systems 110 of the PV modules 57 may be designed for maximum mechanical efficiency and not maximum speed, and therefore might not be practical for use in scouting out higher-radiation orientations. The provision of separate, higher-speed irradiance scanners 81, which in a non-limiting example can comprise small PV panels, facilitates determining target orientations more quickly. In some embodiments, the maximum angular speed of the irradiance scanner is least 2 times faster than the maximum angular speed of the PV modules, or at least 3 times faster, or at least 5 times faster, or at least 10 times faster. In some embodiments, the orientation offering measured or calculated diffuse (and/or total) irradiance greater than at the on-sun orientation is determined using a sky-facing sensor 82 such as a sky-facing optical camera. In example, images from a sky-facing camera are analyzed to map visibly brighter portions of the overhead sky. In some embodiments, the determination of higher-irradiance orientations is carried using both a sky-facing optical camera and an irradiance scanner. In some embodiments, the sky-facing optical camera is the same sky-facing optical camera used in generating images for predicting the return of the direct-component predominance. In some embodiments, it can be desirable, when operating a large solar energy system 100, to deploy more than one sky-facing camera, and/or more than one irradiance sensor. An example of an irradiance sensor 81 is also shown in FIG. 9, in proximity to a PV module 57.

In a solar energy system 100 comprising multiple rows of single-axis PV modules 57, i.e., where drive systems 110 of are configured to pivot the plurality of PV modules 57 about respective single longitudinal axes, the PV modules 57 can be deployed in parallel rows or not all in parallel rows. Referring now to FIG. 10, a plurality of PV modules 57 are shown as having respective single longitudinal axes 910, 920 that are not all parallel to each other. In such a case. Similarly, as illustrated schematically in FIG. 11, it can be desirable to deploy multiple irradiance sensors 81 oriented in different directions for use in a solar energy system 100 comprising two-axis trackers.

Referring now to FIG. 12, a method is disclosed for operating a solar energy system 100, e.g., the solar energy system 100 of FIG. 1. According to the method, the solar energy system 100 comprises a plurality of PV modules 57 and one or more drive systems 110 configured to pivot the plurality of PV modules through respective ranges of orientations. As illustrated by the flow chart in FIG. 12, the method comprises at least the five method steps S11, S12, S13, S14 and S15. Any or all of the steps can be carried out by a controller, e.g., the control system 150 of FIG. 1.

Step S11 includes periodically reorienting the plurality of PV modules 57 to minimize an angular-dependent loss in power output for respective successive sun angles.

Step S12 includes detecting an obscuration of the sun 1.

Step S13 includes reorienting the plurality of PV modules 57 away from an on-sun orientation, in response to the detection of Step S12. In some embodiments, reorienting the plurality of PV modules 57 away from the on-sun orientation is towards an orientation having a measured or calculated diffuse irradiance component greater than currently prevails at the on-sun orientation. In some embodiments, reorienting the plurality of PV modules 57 away from the on-sun orientation is towards an orientation having a measured or calculated total irradiance greater than currently prevails at the on-sun orientation.

Step S14 includes predicting an interval until a cessation of the obscuration based on an image or plurality of images received from a sky-facing camera 82.

Step S15 includes reorienting the plurality of PV modules 57 back towards an on-sun orientation based on the prediction of the interval.

In some embodiments, the predicting of Step S14 is carried out before reorienting the plurality of PV modules away from the on-sun orientation in Step S13.

In some embodiments, the reorienting the plurality of PV modules 57 away from the on-sun orientation in Step S13 and reorienting the plurality of PV modules 57 back toward the on-sun orientation in Step S15 are intended to maximize a cumulative electrical output from photovoltaic conversion of incident solar irradiance over a duration comprising at least the interval. In some embodiments, the reorienting the plurality of PV modules 57 away from the on-sun orientation in Step S13 and reorienting the plurality of PV modules 57 back toward the on-sun orientation in Step S15 are effective to maximize a cumulative electrical output from photovoltaic conversion of incident solar irradiance over a duration comprising at least the interval.

In some embodiments of the method, not all of the steps are carried out.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A method of operating a solar energy system, the solar energy system comprising a plurality of photovoltaic (PV) modules and one or more drive systems configured to pivot the plurality of PV modules through respective ranges of orientations, the method comprising:
a. during a first period of time characterized by a predominance of a direct component in real-time solar irradiance incident on the plurality of PV modules, periodically reorienting the plurality of PV modules to maximize an instantaneous electrical output from photovoltaic conversion of the incident solar irradiance; and
b. during a second period of time characterized at least at a beginning thereof by a predominance of a diffuse component of the real-time solar irradiance incident on the plurality of PV modules and further characterized at least at an end thereof by a predominance of the direct component, reorienting the plurality of PV modules to a plurality of orientations so as to maximize a cumulative electrical output from photovoltaic conversion of the incident solar irradiance over the duration of the second period of time,
wherein at least a first reorienting during the second period of time is effective to pivot the plurality of PV modules away from an on-sun orientation.

2. The method of claim 1, wherein the at least a first reorienting is towards an orientation having a measured or calculated diffuse irradiance component greater than at the on-sun orientation.

3. The method of claim 2, wherein the orientation having a measured or calculated diffuse irradiance component greater than at the on-sun orientation is determined using an image from a sky-facing optical camera.

4. The method of claim 1, wherein the measured or calculated diffuse irradiance component greater than at the on-sun orientation is a maximum diffuse irradiance component at or proximate to a time of the at least a first reorienting during the second period of time.

5. The method of claim 1, wherein the at least a first reorienting during the second period of time is towards an orientation having a measured or calculated total irradiance greater than at the on-sun orientation.

6. The method of claim 4, wherein the orientation having a measured or calculated total irradiance greater than at the on-sun orientation is determined using an image from a sky-facing optical camera.

7. The method of claim 5, wherein the measured or calculated total irradiance greater than at the on-sun orientation is a maximum total irradiance at or proximate to a time of the at least a first reorienting during the second period of time.

8. The method of claim 2, wherein the orientation having a measured or calculated diffuse irradiance component greater than at the on-sun orientation is determined using an irradiance scanner having a maximum angular speed as least 5 times faster than a maximum angular speed of the PV modules when the PV modules are pivoted by the one or more drive systems.

9. The method of claim 5, wherein the orientation having a measured or calculated total irradiance greater than at the on-sun orientation is determined using an irradiance scanner having a maximum angular speed at least 5 times faster than a maximum angular speed of the PV modules when the PV modules are pivoted by the one or more drive systems.

10. The method of claim 1, wherein at least one reorienting during the second period of time that is not the first reorientation is towards an on-sun orientation, and is carried out in response to a predicted increase in the direct component.

11. The method of claim 10, wherein the predicted increase in the direct component is based on an image from a sky-facing optical camera.

12. The method of claim 8, wherein
i. the one or more drive systems are configured to pivot the plurality of PV modules about respective single longitudinal axes,
ii. the respective single longitudinal axes of the plurality of PV modules are not all parallel to each other, and
iii. the irradiance scanner comprises at least two irradiance sensors oriented in different directions.

13. The method of claim 8, wherein
i. the one or more drive systems are configured to pivot the plurality of PV modules through at least respective hemispheres of orientations, and
ii. the irradiance scanner comprises at least two irradiance sensors oriented in different directions.

14. A controller configured to carry out the method of claim 1.

15-19. (canceled)

20. A method of operating a solar energy system, the solar energy system comprising a plurality of photovoltaic (PV) modules and one or more drive systems configured to pivot the plurality of PV modules through respective ranges of orientations, the method comprising:
a. periodically reorienting the plurality of PV modules to minimize an angular-dependent loss in power output for respective successive sun angles;
b. detecting an obscuration of the sun;
c. in response to the detection, reorienting the plurality of PV modules away from an on-sun orientation;
d. predicting an interval until a cessation of the obscuration based on an image received from a sky-facing camera; and
e. reorienting the plurality of PV modules back towards an on-sun orientation based on the prediction of the interval.

21. The method of claim 20, wherein reorienting the plurality of PV modules away from the on-sun orientation is towards an orientation having a measured or calculated diffuse irradiance component greater than at the on-sun orientation.

22. The method of claim 20, wherein reorienting the plurality of PV modules away from the on-sun orientation is towards an orientation having a measured or calculated total irradiance greater than at the on-sun orientation.

23. The method of claim 20, wherein reorienting the plurality of PV modules away from the on-sun orientation and reorienting the plurality of PV modules back toward the on-sun orientation are effective to maximize a cumulative electrical output from photovoltaic conversion of incident solar irradiance over a duration comprising at least the interval.

24. The method of claim 20, wherein the predicting is carried out before reorienting the plurality of PV modules away from the on-sun orientation.

25. A controller configured to carry out the method of claim 20.
